(19) United States
(12) Patent Application Publication
(10) Pub. No.: US 2007/0295844 A1
(43) Pub. Date: Dec. 27, 2007

(54) Vertical Shaft Impact Crusher

(76) Inventor: Yong Gan Ha, Chungcheongbuk-do (KR)

Correspondence Address: LEXYOUME IP GROUP, LLC, 1233 TWENTIETH STREET, N.W., SUITE 701, WASHINGTON, DC, 20036, US

(21) Appl. No.: 11/569,569

(22) PCT Filed: May 23, 2005
(86) PCT No.: PCT/KR05/01492

§ 371 Date: Apr. 2, 2007

(30) Foreign Application Priority Data
May 24, 2004 (KR) 10-2004-0036954
May 20, 2005 (KR) 10-2005-0042327

(51) Int. Cl. B02C 13/14

(52) U.S. Cl. 241/279

(57) ABSTRACT

The present invention relates to a vertical shaft impact crusher, and more specifically, to a vertical shaft impact crusher designed to be able to efficiently crush objects to be crushed and maximize the lifespan of a rotor. For this purpose, the vertical shaft impact crusher includes: a lower rotor element composed of a rotary disk mounted on a rotary shaft and a pipe-like outer peripheral wall installed on the disk concentrically with the rotary shaft and having formed therein an upwardly opened, funnel-shaped protective layer; an upper rotor element which is larger than the lower rotor element, located above the lower rotor element, composed of a circular cover having an inlet port for objects to be crushed and an outer peripheral wall formed below the cover concentrically with the rotary shaft, and having formed therein a downwardly opened, funnel-shaped protective layer which is larger in height and diameter than the protective layer of the lower rotor element and formed so as to overlap the protective layer of the lower rotor element in height and a plurality of rotor legs extending from the periphery of the lower rotor element toward the inner surface of the upper rotor element so as to connect the lower rotor element with the upper rotor element to rotate them together.

### TECHNICAL FIELD

The present invention relates to a vertical shaft impact crusher, and more particularly to a vertical shaft impact crusher configured to maximize the lifetime of a rotor while effectively crushing an object to be crushed.

### BACKGROUND ART

Generally known in the art, an impact crusher is an apparatus for crushing a target object by colliding an impact body of a high relative velocity into the target object, and is generally classified into a horizontal shaft impact crusher and a vertical shaft impact crusher.

The horizontal shaft impact crusher is an apparatus where an impact body for impacting a target object is attached to a horizontal rotating shaft so as to impact and crush the object supplied from the upside while rotating at a high speed. A hammer mill and the like generally belong to this crusher. This crusher has a simple structure, but has a drawback in that the impact body is worn out in short time. For example, when this crusher is used to crush the general rocks for 20 through 30 hours, the impact body thereof is completely worn out.

Thus, the horizontal shaft impact crusher is used for crushing only a target object having a lower hardness such as limestone.

The vertical shaft impact crusher is in turn classified into one having a protective layer made of an object such as a rock on an inner wall of the rotor thereof, and another having no a protective layer on the inner wall of the rotor thereof.

FIG. 1 is a sectional view of a vertical shaft impact crusher of the prior art, and FIG. 2 is a perspective view of a rotor of the impact shaft. In particular, the rotor without the protective layer according to the prior art generally has a similar structure as an impeller of a centrifugal type liquid pump such that a rotating shaft 800 is rotatably mounted vertically therein by a bearing (not shown), and the rotor 802 and a drive pulley 804 are mounted above and below, respectively, the rotating shaft 800.

On the rotor table 806, are radically disposed four or five supporting plates 808, to which a heavy rotor liner plate 810 (called shoe) of a wear resistance cast steel is attached.

The circumferential speed of the rotor 802 ranges from 30 m/sec at operation to 90 m/sec. Outside of and spaced apart from the rotor 802, a heavy stator 812 made of tens of wear resistant cast steels is disposed in a circular shape inside a crusher housing 814.

In such a vertical shaft impact crusher, when a target object like a rock is introduced into a hopper 816 installed above the rotor 802, the target object contacts the center portion of the rotor 802, is impacted and crushed by the rotor liner plate 810 that is smoothly accelerated and thus rotated at a high speed, and is finally blown off and impacted against the circularly disposed stator 812, being crushed again thereby. Then, the crushed pieces of the target object are discharged downwards therefrom.

Such a vertical shaft impact crusher having no a protective layer has good crushing efficiency because the impact operation on the target object is directly performed. Also, the crusher can crush a relatively large target object of 100 mm or more. However, since the rotor plate 810 impacted against the target object at a high speed is subjected to a severe wearing operation, there is caused a problem that its lifetime becomes considerably shorter.

In the event of crushing the general rock containing silica in an amount of about 60%, the lifetime of the rotor liner plate (shoe) 810 is no more than tens of hours. Comparing the lifetime of the liner of different kind of crusher such as a cone crusher reaching 1000 hours or more, it can be seen that the lifetime thereof is considerably short.

In order to solve a wear problem in the rotor liner plate, the vertical shaft impact crusher with the protective layer has been introduced.

FIG. 3 is a sectional view of the vertical shaft impact crusher with the protective layer according to the prior art, and FIG. 4 is a perspective view of the rotor thereof. This kind of crusher has two types of protective layers, i.e., stone pockets. A first stone pocket 902 is provided to the stator 900, and a second stone pocket 906 is provided to the rotor 904. The first stone pocket 902 on the stator 900 is formed in an inclined shape due to effects of gravitation and internal friction angle of the stone pocket forming materials, by which its inner surface makes a funnel-like general configuration.

The second stone pocket 906 on the rotor 904 is formed through deposition on a supporting plate 908 by a centrifugal force. Herein, what is to determine the deposited shape is an internal friction angle of the deposited stones.

If the friction angle is large, a severely curved deposition stack is formed, and if it is small, a gradually curved deposition stack is formed. The internal friction angle is generally determined by stone shapes. That is, if the shape is round, the internal friction angle becomes smaller, and if the shape is angled, the friction angle becomes larger.

The first stone pocket 902 on the stator 900 completely covers the stator 900 so that there is no portion of the stator 900 is exposed to the impacting high speed target object. Then, the stator portion therefore has a prolonged lifetime. However, the second stone pocket 906 on the rotor 904 does not provide sufficient protection against external impact. The serious weak point is a tip portion 910 at the end of the stone pocket.

When introduced from the hopper 912, the target object is impacted and first crushed by the second stone pocket 906 formed on the rotor, and then brown off from the rotor 904 while being accelerated. During the acceleration, the target object under strong force is impacted by the stone pocket 906 and finally by the tip portion 910, and then blown off therefrom.

If the crushed pieces are small enough with a size of about a few millimeters, when the crushed pieces are impacted upon the tip portion 910, the tip portion is merely worn out without being broken. However, if the crushed pieces are sized of even tens of millimeters, the tip portion is continuously worn out and damaged with an impacting shock so that its lifetime is shortened.

In order to increase the lifetime of the tip portion 910 against wear, a plate type member made from hard metal is inserted into the tip portion 910, but it is quickly broken as the crushed pieces are increased in size. Accordingly, it is general that in such a vertical shaft impact crusher as having the rotor 904 of this shape, the target object of 40 mm or more is screened and removed with a screen, and only the target object below the size is supplied.

Even the target object is introduced while being restricted in size thereof like above, the tip portion 910 is continuously worn out to some extent, so that its lifetime is shortened. According to experiences of companies that have been using such a crusher for a long time, the hard metal tip portion should be generally exchanged for 1 or 2 weeks.

Further, another factor of damaging the rotor 904 is that the target objects impacted and crushed by the stone pocket 902 of the stator 900 are scattered and collide into the outer circumferential surface of the rotor 904.

It is normal that the target objects are reduced in moving speed and dropped downwards after the impact upon the stone pocket 902 of the stator. However, there occurs a phenomenon that some of the target objects are rebounded toward the rotor 904 to collide into the outer circumferential surface of the rotor rotating at a high speed. As a result, this causes a problem that the rotor 904 is gradually broken and finally discarded.

As described above, the crusher in the prior art has a limited performance due to wear, so that the size of the target objects to be treated is also restricted.

### DISCLOSURE OF THE INVENTION

Technical Problem

Accordingly, the present invention has been made to solve the foregoing problems occurring in the prior art, and it is an object of the invention to provide a vertical shaft impact crusher in which a protective layer with complete protection function is formed in a rotor to increase the lifetime of the rotor in order to uniformly and effectively crush small and large target objects while extremely increasing the lifetime of the parts.

Advantageous Effects

According to a vertical shaft impact crusher of the present invention, a protective layer is formed in an inclined shape in a rotor, so that the inside of the rotor is completely protected from a wear caused from a contact with the target objects, and the circumferential surface of the rotor is also completely protected from the impact of the target objects because the target objects are discharged upwards or downwards from the rotor, thereby maximizing the lifetime of the rotor.

### BRIEF DESCRIPTION OF THE DRAWINGS

In the drawings:

FIG. 1 is a sectional view of a vertical shaft impact crusher of the prior art, and FIG. 2 is a perspective view of a rotor of the impact shaft;

FIG. 3 is a sectional view of the vertical shaft impact crusher with the protective layer according to the prior art, and FIG. 4 is a perspective view of the rotor thereof;

FIG. 5 is a sectional view of a vertical shaft impact crusher according to a first embodiment of the present invention;

FIG. 6 is a sectional view taken along a line A-A in FIG. 5;

FIG. 7 is a sectional view taken along a line B-B in FIG. 8, illustrating a vertical shaft impact crusher according to a second embodiment of the present invention;

FIG. 8 is a plan view of a lower rotating body of the rotor provided to the vertical shaft impact crusher according to the second embodiment of the present invention, in a state where an upper cover of the rotor is removed while leaving only a lower frame thereof;

FIG. 9 is a sectional view of a vertical shaft impact crusher according to a third embodiment of the present invention;

FIG. 10 is a perspective view of a rotor leg according to a third embodiment of the present invention;

FIGS. 11 through 13 are schematic views of modified protective layers provided to a rotor of a vertical shaft impact crusher according to the present invention;

FIG. 14 is a schematic view of a protective layer provided to a rotor of a vertical shaft impact crusher according to the present invention; and

FIG. 15 is a sectional view of a vertical shaft impact crusher according to a fourth embodiment of the present invention.

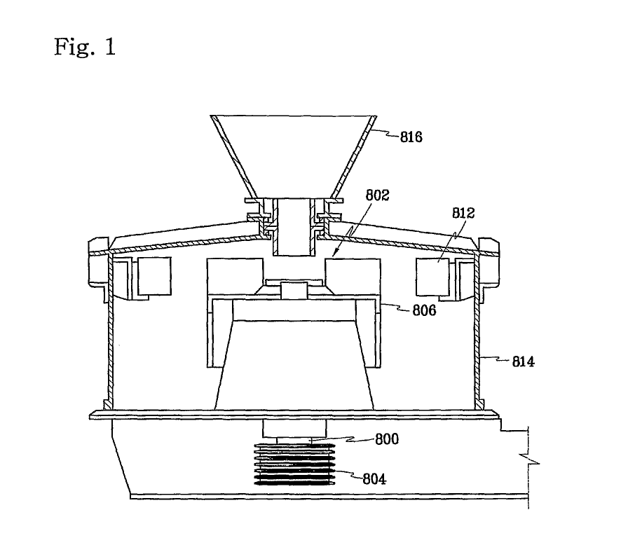

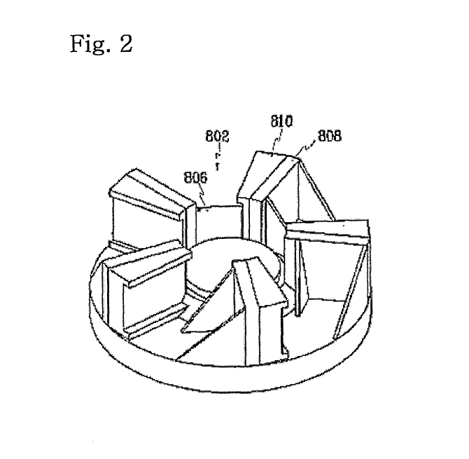

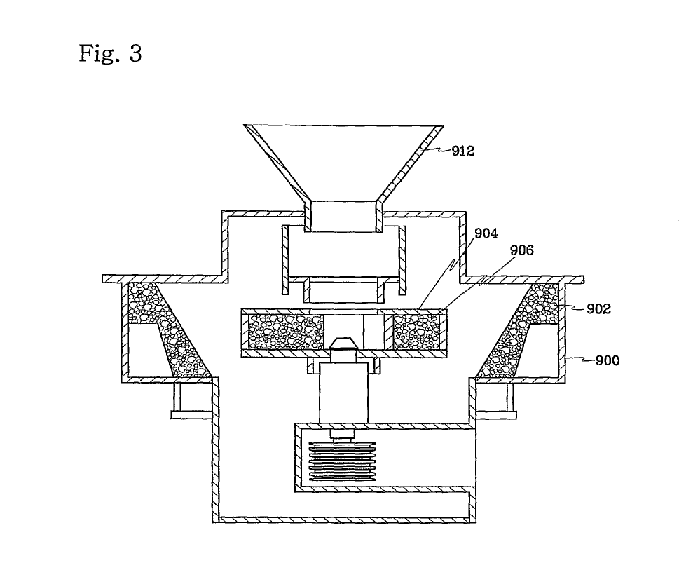

### BRIEF DESCRIPTION OF REFERENCE NUMBER

| | |
|---|---|
| 1,100: rotor | 2: shaft |
| 3,300,320: shield member | 4: outer housing |
| 5: upper cover | 6: hopper |
| 7: bearing housing | 8: pulley |
| 12: boss | 13: rotating body |
| 14: clamp bolt | 15: cover cap |
| 16: protective layer | 31: supporting leg |
| 41: upper portion | 42: step portion |
| 43: protective layer for the stator | |
| 61,610: supply tube | 62: scatter-preventing plate |
| 71: bearing | 72: supporting leg |
| 112: upper cover | 113: upper protective layer |
| 120: lower rotating body | 121: rotating disc |
| 123: lower protective layer | 130: clamp bolt |
| 140: rotor leg | 141: coupling plate |
| 160: protective layer-modifying piece | |
| 200: shaft | 210: upper rotating body |
| 215: rotating body | 310: upper shield section |
| 320: lower shield section | 500: upper cover |
| 701: protective layer-forming piece | |
| 702: height-regulating slot | 703: impact piece |

Best Mode for Carrying Out the Invention

A vertical shaft impact crusher proposed by the present invention is realized by forming in a rotor an inclined protective layer whose inner surface has a sectional shape of funnel. With the inclined protective layer formed in the rotor, the inside of the rotor is completely protected from a wear, and the circumferential surface of the rotor is also completely protected from the impact of the target objects because the target objects are discharged upwards or downwards from the rotor, and so a covering member for the outer circumferential surface of the rotor can be fixedly mounted around the rotor.

The vertical shaft impact crusher of the present invention is configured to include an outer housing serving as a frame as in the vertical shaft impact crusher of the prior art, a rotating shaft bearing housing supported at the inner lower part of the outer housing, a rotor coupled to an upper portion of the rotating shaft to rotate at high speed, a pulley for driving the rotor, a hopper for supplying a target object to the rotor, and an upper cover for covering a chute portion and the upper portion of the outer housing.

A stator is formed by the target objects collected at the upper portion inside the outer housing and upon which the target objects bounded in high speed from the rotor are impacted. As for the stator, a conventional wear resistant metal anvil can be used. The characteristic portions of the present invention are a rotor with an inclined protective layer, and a peripheral device related.

The technical features of the present invention will be described in detail as follows:

The vertical shaft impact crusher of the present invention comprises at least one rotating body positioned at a rotating shaft and to which target objects are introduced from upwards, wherein a protective layer is formed inside the corresponding rotating body such that the introduced target objects are gradually enlarged in diameter along a discharge direction of the rotating body by the rotating movement of the rotating body, thereby forming an inner surface thereof with a sectional shape of funnel.

The vertical shaft impact crusher of the present invention is realized into three specific embodiments, which will be described in detail as follows:

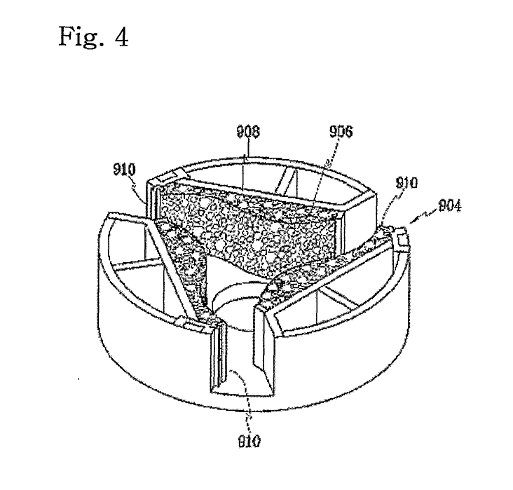

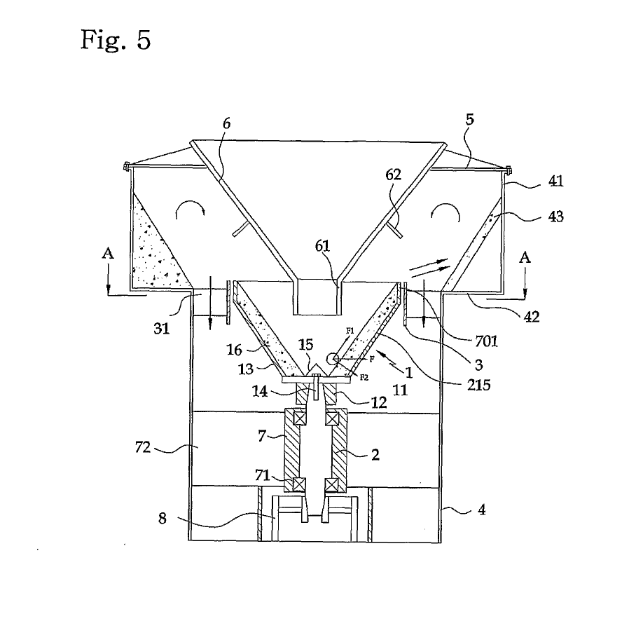

First, a first embodiment of the present invention will be explained with reference to FIG. 5, illustrating a sectional view of a vertical shaft impact crusher.

The present invention relates to a vertical shaft impact crusher comprising a rotating body 215 positioned on a rotating shaft, for receiving target objects introduced from upwards, and a protective layer 16 formed inside the rotating body 215, in which the protective layer 16 has a funnel-shaped inner surface as the introduced target objects are gradually enlarged in diameter along an upward direction of the rotating body 215 by the rotating movement of the rotating body 215.

Further, a scatter-preventing plate 62 is mounted to a back surface of a funnel type hopper for introducing the target objects in the rotating body 215, in order not to allow the target objects deviated from the rotating body 215 to be returned in the rotating body 215.

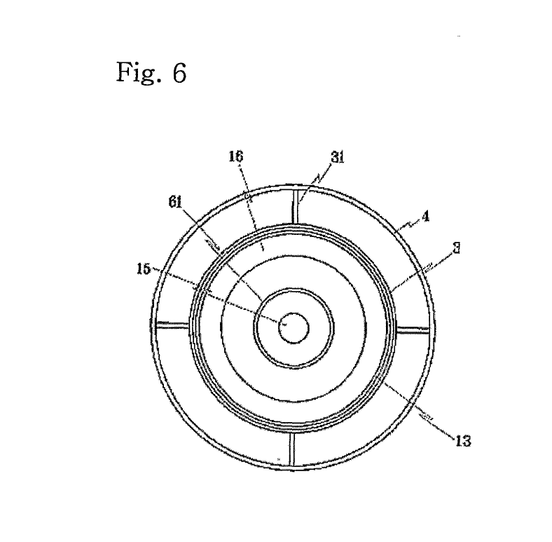

FIG. 6 is a sectional view taken along a line A-A in FIG. 5. To be specific, there is provided a shield member 3 that extends downwards from the same height as the upper portion of the rotating body 215 and has a shape of ring larger than a diameter of the rotating body 215. The shield member 3 is provided to protect the circumferential surface of the rotating body 215 from the scattering target objects deviated from the protective layer 16 formed in the rotating body 215.

Hereinafter, the first embodiment of the present invention will be more specifically described referring to accompanying FIGS. 5 and 6.

A rotor 1 is funnel-shaped as a whole, in which a funnel type rotating body 215 is formed in an upper portion and a boss 12 is formed at a lower portion 11 of the circular rotator for the purpose of connection with a shaft 2.

The rotor 1 is coupled with the shaft 2 by a clamp bolt 14, and a cover cap 15 covers the clamp bolt 14 for preventing the same from being worn out.

A reference numeral 16 in the rotating body 215 indicates a protective layer formed in the rotor. The protective layer 16 is constructed such that small and large particles of the target object to be crushed, and viscous fine clay components are firmly agglomerated by a centrifugal force, so that the shape thereof is maintained even after the interruption of the rotor 1.

The circumference of the upper rotor 1 is surrounded by a shield member 3 which is fixed to and supported by an outer housing 4 by means of a supporting leg 31.

An upper portion 41 of the outer housing 4 of the crusher is formed with a step portion 42 larger in diameter than a lower portion of the outer housing so that a protective layer 43 for a stator is formed in the outer housing 4 while being agglomerated with the target objects in an inclined shape. Also, an upper cover 5 covers the upper portion of the outer housing 4, and a hopper 6 is coupled at the center of the upper cover 5.

A target object supply tube 61 is attached to the lower end of the hopper 6. At the back surface of the hopper above the target object supply tube 61, a scatter-preventing plate 62 is attached so as to return the irregularly scattering target objects into the rotor 1, and to prevent the scattering target objects crushed at the protective layer for the stator from being introduced into the rotor.

The shaft 2 is rotatably supported by a bearing 71 and a bearing housing 7, in which the bearing housing 7 is fixed to and supported by the outer housing 4 by means of a supporting leg 72. A reference numeral 8 as not explained indicates a pulley for driving the rotating shaft 2. For convenience, a detailed structure like a labyrinth seal for preventing dust from introducing into the bearing 71 will not be illustrated.

Hereinafter, an operation of the vertical shaft impact crusher of the present invention will be described.

First, the target objects (stones) are introduced near the center portion of the rotor rotating at a high speed through the supply tube 61. Inside the rotating body 215, the protective layer 16 is formed of the target objects deposited into a funnel-like surface shape so as to tightly coat the inside of the rotating body 215.

Accordingly, the introduced target objects obtain a rotation speed while being impacted near the center portion of the rotating protective layer 16, and at the same time, they are closely contacted with the protective layer 16 by a centrifugal force.

Then, the target objects closely contacted with the protective layer 16 obtain a speed substantially identical to that of the protective layer 16. Provided that a centrifugal force pressing the target objects against the protective layer 16 is F, F is divided into a vertical partial force F2 perpendicular to the protective layer 16, and a horizontal partial force F1 horizontal to the protective layer 16.

F1 tends to draw up the target objects along an inclined surface of the protective layer 16 and F2 causes a friction force, so that a new friction force reacted in opposite direction of F1 is generated. Since the friction force however is smaller than F1, the target objects are rolled up along the inclined surface of the protective layer 16.

As the target objects are rolled up along the inclined surface of the protective layer 16, the diameter of the inclined protective layer is increased. Thus, the circumferential speed of the target objects closely contacted with the inclined surface by the friction force becomes larger, and finally obtain a speed substantially identical to a maximum circumferential speed of the rotation body 215 when they leave the rotation body 215 at the upper end of the rotor 1. A rising speed of the target objects along the inclined surface is relatively low compared to the circumferential speed thereof.

The high speed target objects left from the rotating body 215 are impacted and crushed by the protective layer 43 for the stator formed of the deposited target objects and thus reduced in speed. Then, the crushed target objects are dropped downwards through a ring shaped space between the outer housing 4 and the shield member 3 surrounding the outer portion of the rotating body 215.

When the target objects are crushed by the impact upon the protective layer 43 for the stator, some of them show an irregular scattering behavior, but they cannot be impacted upon the circumference of the rotating rotor 1 by means of the shield member 3, so that the circumference of the rotating body 215 is not subjected to a damage like wear. This is possible because the target objects are discharged from the end of the rotating body 215.

That is, in case of the conventional vertical shaft impact crusher, the target objects are discharged through the circumferential surface of the rotor so that it is basically impossible to mount the shielding member for protecting the circumferential surface of the rotor from the target object pieces. As a result, in the prior art, there was not a method for preventing the target object pieces from being impacted upon the circumferential surface of the rotor, so that the circumferential surface of the rotor was severely worn out by the impact of the target object pieces upon the circumferential surface of the rotor rotating at high speed.

Accordingly, although the circumferential surface of the rotor is coated with annealed hard material, there causes a problem that the circumferential surface should be repaired periodically or otherwise the rotor itself should be disused.

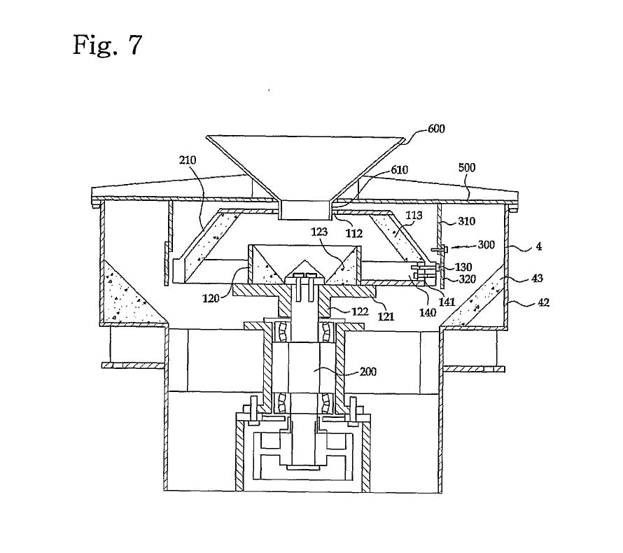

Hereinafter, a second embodiment of the present invention will be explained with reference to FIG. 7 illustrating a sectional view of a vertical shaft impact crusher.

The construction constituting the second embodiment of the present invention comprises an upper rotating body 210 positioned on the rotating shaft, and a lower rotating body 120 positioned below the upper rotating body 210, wherein a lower protective layer 123 is formed inside the lower rotating body 120 such that the target objects introduced from the upside are gradually enlarged in diameter along an upward direction of the lower rotating body 120 by the rotary movement of the lower rotating body 120, thereby forming an inner surface thereof with a sectional shape of funnel, wherein an upper protective layer 113 is formed such that the target objects escaped from the lower protective layer 123 are moved along an inside height of the upper rotating body 210, wherein the diameter of the upper protective layer 210 is larger than the lower protective layer 120, and wherein the upper protective layer 113 is formed in an inverse funnel shape relative to that of the lower protective layer 123.

A hole 112 is formed at upper and center portion of the upper rotating body 210 so as to introduce the target objects there through, and the upper protective layer 113 is formed inside the upper rotating body 210. The shape of the upper protective layer 113 is determined by a centrifugal force and an internal friction angle between the target objects. The upper protective layer 113 is constructed such that small and large particles of the target objects to be crushed and viscous fine clay components are firmly agglomerated by a centrifugal force of the rotating bodies 210 and 120, so that the shape thereof is maintained even after the interruption of the rotating bodies 210 and 120 without being broken.

A boss 122 is formed downwards from a rotating disc 121 so as for the connection with a shaft 200, and the lower rotating body 120 is mounted upwards from the rotating disc 121 so as to form the lower protective layer 123.

The vertical shaft impact crusher with two protective layers as above operates as follows: First, when the target objects are introduced into the inside of the rotor 100 through the hopper 600 and the supply tube 610, the target objects are firstly impacted upon the center portion of the lower protective layer 123. The target objects obtain a rotating speed by the impact, are moved upwards and accelerated along the inclined surface of the lower protective layer 123 while being closely contacted with the inclined surface by a centrifugal force, and finally escape the lower protective layer 123.

The procedure up to here is identical to the accelerating procedure of the target objects as in the first embodiment in FIG. 5. The target objects leaving the lower protective layer 123 are in turn impacted by the upper portion of the upper protective layer 113 and then accelerated while being closely contacted with the upper protective layer 113 by a centrifugal force. Then, the target objects are accelerated while being rolled down along the inclined surface of the upper protective layer 113, and finally leave the upper rotating body 210 at the lower end of the upper protective layer 113.

The target objects leaving the upper rotating body 210 are crushed through the impact upon the protective layer 43 for the stator formed in the step portion 42 and then decreased in speed so as to be discharged downwards like in the first embodiment.

The target objects deviated from the upper rotating body form the protective layer 43 for the stator through the impact upon the stator to be decreased in speed and to thus be collected thereto, and the target objects deviated from the protective layer 43 for the stator are dropped downwards.

The rotor 100 consisting of the upper rotating body 210 and the lower rotating body 120 is characteristically configured such that the upper and lower protective layers 113 and 123 are overlapped to each other, so that the height of the rotor 100 is lower than the total length of the protective layers 113 and 123, and the height of the crusher is considerably reduced as a whole because the target objects are discharged downwards from the rotor 100.

Accordingly, in order to considerably reduce a size in vertical length direction in the crusher of the present invention, the upper rotating body 210 is so positioned as to be partially overlapped with the inside height of the lower rotating body 120, so that the upper and lower protective layers 113 and 123 are overlapped to each other based on a horizontal reference.

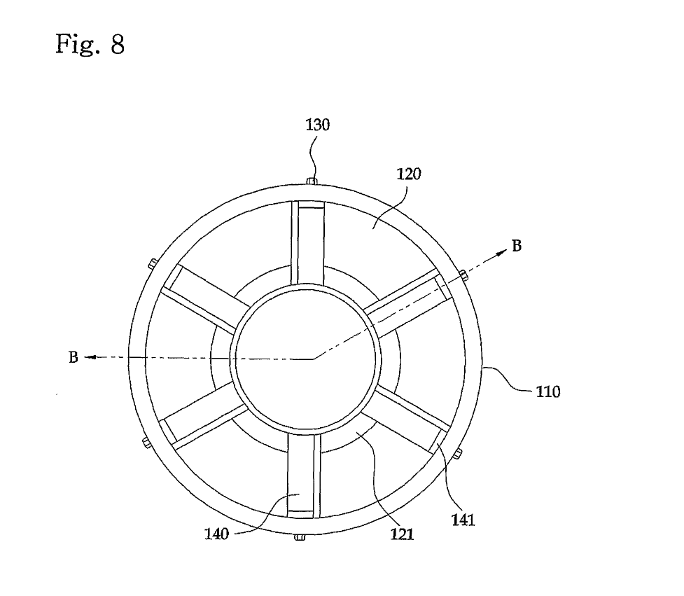

The rotor 100 of the impact crusher according to the second embodiment of the present invention is configured to include the upper rotating body 210 and the lower rotating body 120. The upper rotating body 210 and the lower rotating body 120 are individually manufactured and machined, and then coupled with each other by a clamp bolt 130. To this end, as shown in FIG. 8, a plurality of rotor legs 140 are horizontally extended from the lower portion of the lower rotating body 120 toward the lower portion of the upper rotating body 210 so as to couple the upper and lower rotating bodies with each other. The rotor legs consist of 3 to 6 rotor legs.

The end portion of the rotor leg 140 is terminated as a rectangular coupling plate 141 whose outer surface is precisely machined corresponding to a curvature of inner surface of the lower portion of the upper rotating body and to which a hole is formed to engage with the clamp bolt 130.

Outside of the upper and lower rotating bodies 210 and 120, a shield member 300 is mounted to an upper cover 500 so as to protect the rotating bodies from the scattering target object pieces. The shield member 300 consists of an upper shield section 310 and a lower shield section 320 which are detachably coupled to each other by a bolt. The shield member 300 is formed in a ring shape larger than the diameter of the upper rotating body 210 along the whole height including the upper and lower rotating bodies 210 and 120, thereby protecting the circumferential surfaces of the upper and lower rotating bodies from the scattering target objects.

Also, although the target objects are irregularly scattered at the lower protective layer 123, they are precisely accelerated and discharged without being escaped to outside by means of the upper cover 112 of the rotor.

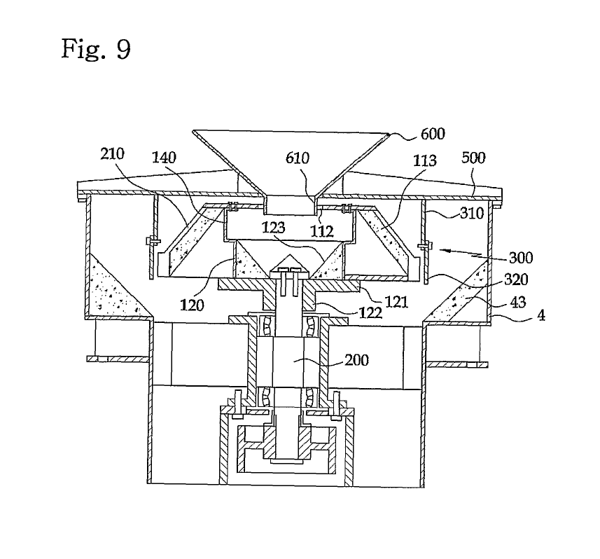

FIG. 9 is a sectional view of a vertical shaft impact crusher according to a third embodiment of the present invention. Specifically, the upper and lower rotating bodies 210 and 120 are separately manufactured, and fixedly coupled with each other by using a plurality of vertical rotor legs 140.

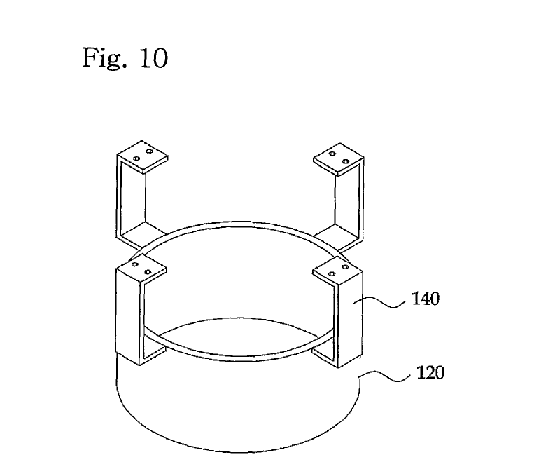

The plural rotor legs 140 are extended from the outer circumferential edge of one side of the lower rotating body toward the inner circumferential edge of one side of the upper rotating body so as to fixedly couple the upper and lower rotating bodies with each other. More specifically, referring to FIG. 10 illustrating a perspective view of a rotor leg according to a third embodiment of the present invention, the plural rotor legs 140 are vertically extended from the upper portion of the lower rotating body 120 toward the upper portion of the upper rotating body 210 so as to fixedly couple the upper and lower rotating bodies with each other. The rotor legs 140 consist of 3 to 6 rotor legs.

The end portion of the rotor leg 140 is formed with a female thread hole for bolt-coupling through which the clamp bolt is fixedly screwed. Explaining an operation of the crusher with the rotor legs, when introduced into the rotor 100, the target objects are impacted upon the center portion of the lower protective layer 123, accelerated while being rolled up along the inclined surface of the protective layer to leave the lower protective layer 123, and then impacted upon the upper portion of the upper protective layer 113 through the space defined by a distance of the rotor legs 140, thereby forming the upper protective layer 113.

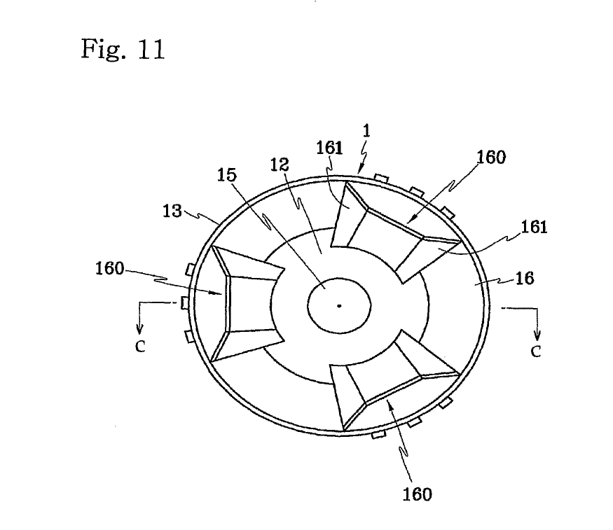

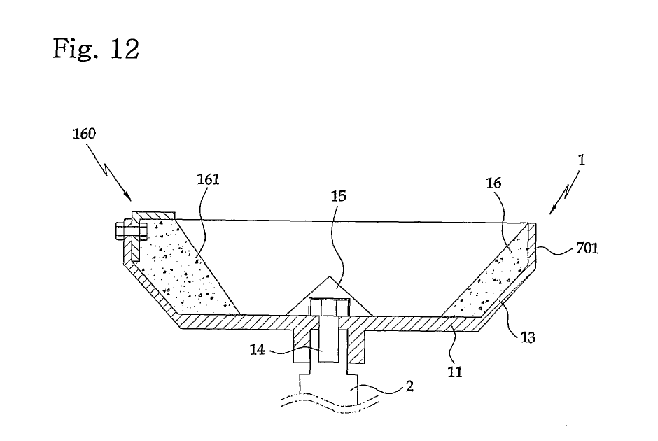

FIGS. 11 through 13 are plan views and an enlarged sectional view, respectively, of a protective layer-modifying piece provided to a rotor of a vertical shaft impact crusher according to the present invention, in which the protective layer-modifying piece 160 is mounted to the upper portion of the rotating bodies 120, 215 and 210 so as to form a curved portion to the protective layers of the rotating bodies. With the installation of protective layer-modifying piece 160, the target objects are deposited much more under the modifying piece 160 rather than the other protective layer 16, so that a convex modified protective layer 161 is formed.

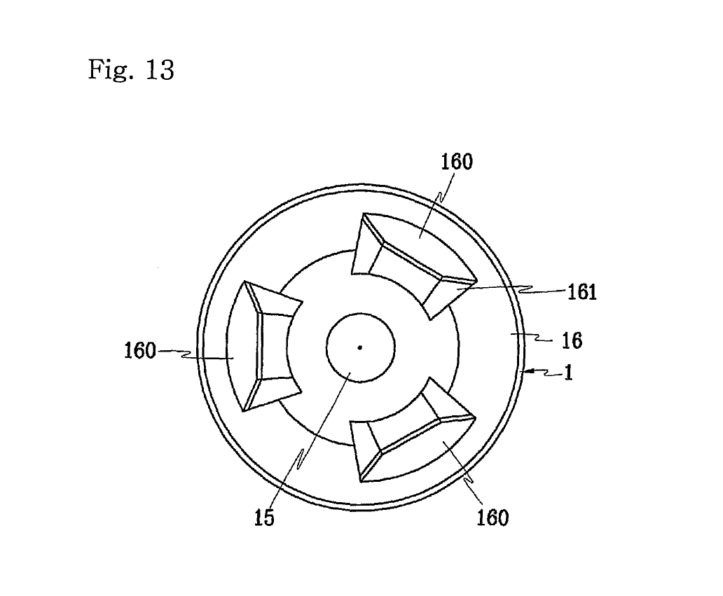

The modified protective layer 161 curved like above affords an effect that even when the target objects have a relatively large size, they are effectively crushed in the rotor and also their accelerating operation is enhanced. The modifying piece 160 may be mounted to the middle portion of the rotor rather than the upper portion of the rotor as shown in FIG. 13.

The target objects deviated from the protective layers formed in the rotating bodies shown in the first to third embodiments of the present invention form the protective layer 43 for the stator at the step portion 42 of the upper portion of the outer housing 4, by which a wear is prevented upon the impact of the heavy metal pieces deviated from the rotating bodies.

The shape of the rotating bodies 215, 120 and 210 for forming the protective layers 16, 113 and 123 in the rotating bodies 215, 120 and 210 according to the first to third embodiments above is classified into two types.

First type is a funnel shape, in which the inner diameters of the rotating bodies 215, 120 and 210 are identical along the upward direction, and the protective layers 16, 113 and 123 are so formed in the rotating bodies as to be enlarged in diameter along the discharge direction of the target objects to thus form the funnel shape.

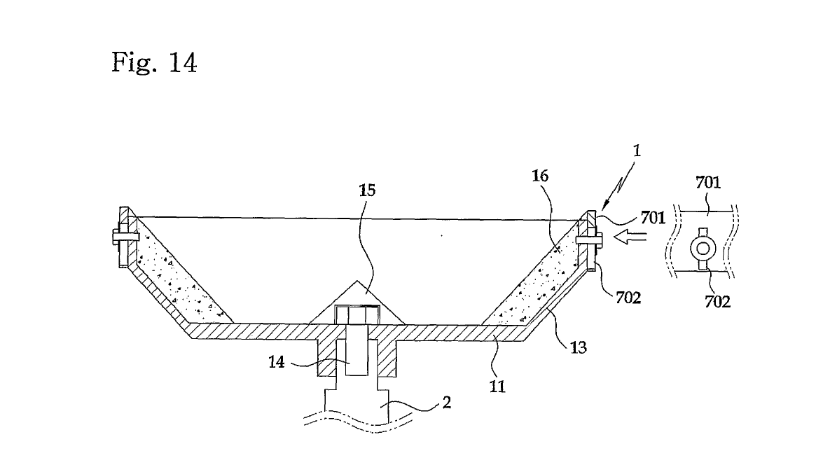

Second type is another funnel shape as shown in FIG. 14, in which the inner diameters of the rotating bodies 215, 120 and 210 are formed in a funnel shape enlarging in diameter along the upward direction of the target objects. In this case, a protective layer-forming piece 701 is integrally formed to the end portion of the rotating bodies 215, 120 and 210 so as to form the protective layers 16, 113 and 123 in the rotating bodies 215, 120 and 210.

Alternatively, the protective layer-forming piece 701 may be separately manufactured so as to easily exchange it for a new one, if needed, because the end portion of the rotating bodies is a point where the target objects are deviated and likely to be worn rather than other portions. The protective layer-forming piece 701 has at least one height-regulating slot 702 to regulate a height thereof.

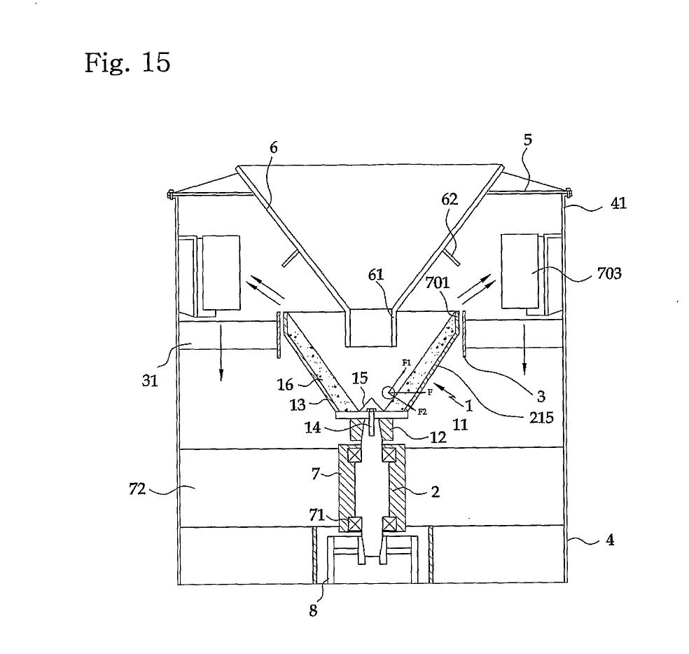

FIG. 15 is a sectional view of a vertical shaft impact crusher according to a fourth embodiment of the present invention, which will be explained below.

In the fourth embodiment, a plurality of wear resistant impact pieces 703 are attached to the inside of the upper portion of the outer housing 4 so that the target objects deviated from the protective layer of the rotating body are impacted thereon, whereas, in the first to third embodiments, the protective layer 43 for the rotator is formed at the step portion 42 of the upper portion of the outer housing 4 so that the step portion is protected from wear upon the impact of the heavy metal pieces deviated from the rotating body. In such fourth embodiment, the protective layer for stator is not formed, and the target objects are crushed into pieces and dropped downwards through the impact upon the impact pieces 703.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A vertical shaft impact crusher, comprising at least one rotating body positioned on a rotating shaft to receive target objects introduced from upward and a protective layer formed inside the corresponding rotating body, wherein the protective layer has a funnel-shaped inner surface as the introduced target objects are gradually enlarged in diameter along a discharge direction of the rotating body by the rotating movement of the rotating body

2. A vertical shaft impact crusher, comprising a rotating body positioned on a rotating shaft to receive target objects introduced from upwards and a protective layer formed inside the rotating body, wherein the protective layer has a funnel-shaped inner surface as the introduced target objects are gradually enlarged in diameter along an upward direction of the rotating body by the rotating movement of the rotating body.

3. A vertical shaft impact crusher, comprising an upper rotating body positioned on a rotating shaft, and a lower rotating body positioned below the upper rotating body, wherein a lower protective layer is formed inside the lower rotating body such that the target objects introduced from the upside are gradually enlarged in diameter along an upward direction of the lower rotating body by the rotating movement of the lower rotating body, thereby forming an inner surface thereof with a sectional shape of funnel, wherein an upper protective layer is formed such that the target objects escaped from the lower protective layer are moved along an inside height of the upper rotating body, wherein the diameter of the upper protective layer is larger than the lower protective layer, and wherein the upper protective layer is formed in an inverse funnel shape relative to that of the lower protective layer.

4. The vertical shaft impact crusher according to any one of the preceding claims 1 to 3, wherein the protective layer is fixedly formed through the impact of the target objects deviated from the protective layer of the rotating body.

5. The vertical shaft impact crusher according to claim 3, wherein the upper rotating body is so positioned as to be partially overlapped with an inner height of the lower rotating body, so that the upper and lower protective layers are overlapped with each other in a vertical length direction.

6. The vertical shaft impact crusher according to claim 3, wherein a plurality of rotor legs are extended from the outer circumferential edge of one side of the lower rotating body toward the inner circumferential edge of one side of the upper rotating body, or a plurality of rotor legs are vertically extended from the upper portion of the lower rotating body toward the upper portion of the upper rotating body, so as to fixedly couple the separately manufactured upper and lower rotating bodies with each other.

7. The vertical shaft impact crusher according to any one of the preceding claims 1 to 3, wherein the inner diameter of the rotating body is formed constantly along an inner height thereof.

8. The vertical shaft impact crusher according to any one of the preceding claims 1 to 3, wherein the inner diameter of the rotating body is formed in a funnel shape enlarging in diameter along a discharge direction of the target objects, and a protective layer forming piece is integrally or detachably attached to the end portion of the rotating body so as to form a protective layer.

9. The vertical shaft impact crusher according to claim 2, further comprising a shield member formed in a ring shape larger than the diameter of the rotating body in such a manner as to extend downwards from the height of the upper portion of the rotating body, for protecting the circumferential surface of the rotating body from the scattering target objects.

10. The vertical shaft impact crusher according to claim 9, wherein the shield member is coupled and supported to the outer housing of the crusher.

11. The vertical shaft impact crusher according to claim 3, further comprising a shield member formed in a ring shape larger than the diameter of the upper rotating body along the whole height of the upper rotating body, for protecting the circumferential surface of the upper rotating body from the scattering target objects.

12. The vertical shaft impact crusher according to claim 2, further comprising a scatter-preventing plate attached to a back surface of a funnel type hopper formed to introduce the target objects in the rotating body.

13. The vertical shaft impact crusher according to any one of claims 1 to 3, further comprising a plurality of protective layer-modifying pieces mounted inside or at the end portion of the respective rotating bodies.

14. The vertical shaft impact crusher according to claim 8, wherein the protective layer-forming piece has at least one height-regulating slot so as to regulate a height thereof.

15. The vertical shaft impact crusher according to any one of claims 1 to 3, further comprising a plurality of wear resistant alloy impact pieces attached to the inside of the upper portion of the outer housing so that the target objects deviated from the protective layer of the rotating body are impacted thereon.
